(19) United States
(12) Patent Application Publication
(10) Pub. No.: US 2003/0118970 A1
(43) Pub. Date: Jun. 26, 2003

(54) Removable dental models

(75) Inventors: Richard P. Rusin, Woodbury, MN (US); Timothy R. Kinsky, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company, St. Paul, MN (US)

(21) Appl. No.: 10/027,319

(22) Filed: Dec. 21, 2001

(51) Int. Cl. A61C 11/00

(52) U.S. Cl. 433/213; 433/60

(57) ABSTRACT

An apparatus and method of use that include a dental model, a support that includes a mounting surface and a stretch release pressure sensitive adhesive located between the dental model and the support. The stretch release pressure sensitive adhesive attaches the dental model to the mounting surface. In an additional embodiment, a highly extensible and substantially inelastic backing having a layer of the stretch release pressure sensitive adhesive is used to attach the dental model to the mounting surface. The dental model and the support are separated without damage by stretching the stretch release pressure sensitive adhesive at an angle no greater than about 35 degrees from the mounting surface.

### FIELD OF THE INVENTION

The invention relates to pressure sensitive adhesive products, particularly stretch removable adhesive articles for releasably mounting items on a mounting surface.

### BACKGROUND

Dental models are widely used for a variety of purposes during the course of dental treatment. As one example, a dentist or prosthodontist may desire to have a model of an area of a patient's oral cavity where one or more teeth are missing or damaged. In that instance, suitable replacement teeth may be made in the laboratory using the model as a guide.

As another example, dental practitioners often use models of a patient's teeth to study malformations or malpositions of the teeth and jaws and plan a course of treatment. Sometimes, models of the patient's entire upper and lower dental arch are mounted on a device known as an articulator. The articulator includes a hinged coupling that enables the models of the arches to swing toward and away from each other in a manner that mimics the opening and closing of the patient's jaws. The practitioner can use the articulator to study the opening and closing movements of the patient's jaws from various angles of view in order to better diagnose any problems and plan an appropriate course of treatment.

As can be appreciated, use of dental models represents a significant convenience for both the practitioner and the patients. When the model is used to construct restorations such as a dental crown, the trial and error fitting procedure can be carried out in the dental laboratory as long as necessary until a proper size and shape is attained. Consequently, the amount of time that the patient must occupy the dental chair in the operatory is reduced.

When dental models are used for purposes of study, the practitioner is able to take as much time as needed to complete the diagnosis and plan an appropriate course of treatment, again without the necessity of keeping the patient in the dental chair. When desired, the models can also be used for educating the patient and explaining various treatment options. Additionally, the models can serve as a permanent record of the patient's oral structures at a particular point in time.

Recently, there has been increased interest in the use of dental models for preparation of dental prosthetics using computer automated design systems. For example, some systems scan dental models to collect a set of electronic data that are representative of the patient's tooth structure of interest. The data set is then used during the operation of an automated mechanical milling machine (such as a computer-aided milling machine) to fabricate a prosthetic that, when completed, closely matches the shape of natural tooth structure.

Examples of computer-aided milling machines used in the field of dentistry include the CEREC 2, CEREC 3 and CEREC SCAN systems available from Sirona Dental Systems of Bensheim, Germany, the VITA CELAY machine from Vita Zahnfabrik of Bad Säckingen, Germany, PRO-SCAN from Cad-Cam Ventures Incorporated, of Dallas, Tex. and PROCERA ALLCERAM from Nobel Biocare USA of Westmont, Ill. U.S. Pat. Nos. 4,837,732 (Brandestini, et al.), 4,776,704 (Kopunek, et al.), and 4,575,805 (Moermann, et al.), as well as International Publication No. WO 96/37163 (Franetzki) also disclose systems for making dental prosthetics using computer-aided milling machines.

One known method of using dental models with computer-aided milling systems involves placing a plate in contact with mold material for making the model before the mold material has hardened. The plate has dovetail-shaped grooves that couple the resulting model to the plate. The plate is then clamped to a fixture while a scanner traverses the model to collect the electronic data.

Other known methods of affixing dental models include the use of pins that are set into the mold material before the mold material hardens. The pins project outwardly from the resultant model to provide a handle for holding the models during a scanning operation. Clamps or other structures are used to couple the pins to a fixture during the scanning operation.

The use of grooved plates and pins in the procedures mentioned above is somewhat unsatisfactory since the plates or pins must be removed from the model and cleaned before subsequent reuse. However, the mold material used to make the model may be difficult to remove from the plates and pins. In some instances, portions of the model that bear the replica surfaces of the patient's oral structures may be damaged when an effort is made to remove the pins or plate such that the model can no longer serve as a record of the patient's oral structures.

Additionally, the practitioner's choice of mold material for the model is somewhat restricted when a grooved plate is employed. For example, plates having dovetail-shaped grooves may necessitate the use of a mold material having a rubbery consistency when cured, so that the plate can be detached from the model. However, such mold materials may not be preferred for other reasons such as permanency, resolution, or hardness. For example, some practitioners prefer to use epoxy-type mold material that cures to a relatively hard mass. Unfortunately, epoxy-type mold material may be deemed too difficult to be removed from the plate with a reasonable amount of effort.

Accordingly, there remains a need in the art for dental models and methods of affixing dental models that enable the practitioner to use essentially any mold material as desired. Moreover, there is a need to improve existing methods and models in order to reduce the time and effort associated with the dental procedure of interest, so that a cost savings can be realized.

### SUMMARY

The present invention relates to removably attaching a dental model to a support with a stretch release pressure sensitive adhesive. The stretch release pressure sensitive adhesive is located, partially or completely, between the dental model and a mounting surface of the support. The stretch release pressure sensitive adhesive attaches the dental model to the support. The support can then be mounted in a computerized scanning device, on a study table, on a workbench, or on an articulator in order to study and analyze the dental model. The dental model and the support are then separable by stretching the stretch release pressure sensitive, where the stretch release pressure sensitive adhesive separates from both the dental model and the mounting surface of the support.

In more detail, the dental model, constructed from mold material, has an exterior surface that defines an upper surface and a base surface. The upper surface of the dental model represents oral structure. The base surface of the dental model is where the stretch release pressure sensitive adhesive can attach the dental model to the mounting surface of the support. The dental model and the support are separable by stretching the stretch release pressure sensitive adhesive at an angle no greater than about 35 degrees from the mounting surface. Removal at the appropriate angle preferably leaves no appreciable adhesive residues and reduces or prevents damage to the mounting surface and the dental model.

In an additional embodiment, the dental model can further include a holder that is secured to the dental model. The holder has a somewhat planar configuration with two sides. One side (i.e., a first side) of the holder has a textured surface that is embedded in the mold material to securely connect the holder to the mold material of the dental model. The stretch release pressure sensitive adhesive can attach the holder to the mounting surface of the support so as to secure the dental model to the support.

In one embodiment, the stretch release pressure sensitive adhesive is an adhesive sheet having a predetermined length, where the adhesive sheet is extensible. The adhesive sheet is removable from the dental model and the support by stretching the adhesive sheet to at least about 50% of the predetermined length of the adhesive sheet. In an alternative embodiment, a layer of the stretch release pressure sensitive adhesive is disposed on a first major surface and a second major surface of a backing. The backing and the stretch release pressure sensitive adhesive are extensible to separate the dental model and the support without rupture of the backing. The stretch release pressure sensitive adhesive may be removable from the dental model and the support by stretching the backing and the stretch release pressure sensitive adhesive to at least about 50% of a predetermined length of the backing. In one example, the backing is substantially non-recoverable after being stretched.

The backing can further include tab portions from which the backing and the stretch release pressure sensitive adhesive can be stretched to separate the dental model and the support. In one embodiment, the backing includes a first tab portion. The first tab portion projects past at least one of the dental model and support to allow a user to grasp and stretch the backing and the stretch release pressure sensitive adhesive. The backing may also include a second tab portion that projects past at least one of the dental model and the support to allow a user to grasp and stretch the backing and the stretch release pressure sensitive adhesive. The first tab portion may oppose the second tab portion across the mounting surface, where the backing and the stretch release pressure sensitive adhesive are stretched from both the first and second tabs portions. The backing can include additional tab portions from which the backing and the stretch release pressure sensitive adhesive can be stretched.

The present invention is also directed to a method of releasably attaching the dental model to the mounting surface of the support. The method may include positioning the stretch release pressure sensitive adhesive between the dental model and the mounting surface of the support, and attaching the dental model to the mounting surface of the support with the stretch release pressure sensitive adhesive. The dental model can then be removed from the mounting surface of the support by stretching the stretch release pressure sensitive adhesive at an angle of no greater than about 35 degrees from the mounting surface of the support. In removing the dental model from the mounting surface of the support, the stretch release pressure sensitive adhesive can be stretched from one direction, or in opposite directions.

The invention also includes a kit. In one embodiment, the kit contains mold material for creating the dental model and stretch release pressure sensitive adhesive for attaching a dental model made from the mold material to a mounting surface of a support. As described, the dental model and the support are separable by stretching the stretch release pressure sensitive adhesive at an angle no greater than about 35 degrees from the mounting surface. The stretch release pressure sensitive adhesive may be disposed on the first major surface and the second major surface of a backing, as described. The backing and the stretch release pressure sensitive adhesive are preferably extensible to separate the dental model and the support without rupture of the backing. The stretch release pressure sensitive adhesive may be removable from the dental model and the support by stretching the backing and the stretch release pressure sensitive adhesive to at least about 50% of a predetermined length of the backing. Stretching of the backing and the stretch release pressure sensitive adhesive may be accomplished using one or more tabs, as described. In an additional example, the backing is substantially non-recoverable after being stretched.

Other aspects of the invention are described in the detailed description that follows and are set out in the accompanying drawings.

### BRIEF DESCRIPTION OF THE DRAWINGS

A more complete understanding of the invention and its advantages will be apparent from the Detailed Description taken in conjunction with the accompanying Drawings, which are not to scale, where:

FIG. 1 is a side view of a dental model according to one embodiment of the present invention;

FIG. 2 is a cross-sectional view of a dental model according to an additional embodiment of the present invention;

FIG. 3 is a perspective view of a dental model according to an additional embodiment of the present invention;

FIG. 4 is a perspective view of a dental model according to an additional embodiment of the present invention;

FIG. 5 is a perspective view of a dental model according to an additional embodiment of the present invention; and

FIG. 6 is an perspective view of a dental kit according to one embodiment of the present invention.

### DETAILED DESCRIPTION OF ILLUSTRATIVE EMBODIMENTS OF THE INVENTION

The present invention provides for removable attachment of a dental model directly to a support with a stretch release pressure sensitive adhesive. The stretch release pressure sensitive adhesive is located, partially or completely, between the dental model and a mounting surface of the support, where the stretch release pressure sensitive adhesive attaches the dental model to the support. The support can then be mounted in a computerized scanning device, on a study table, on a workbench or on an articulator in order to study and analyze the dental model. The dental model and the support are separable by stretching the stretch release pressure sensitive, where the stretch release pressure sensitive adhesive separates from both the dental model and the mounting surface of the support.

One advantage of the present invention is that the dental model can be quickly and cleanly released from the support structure. Unlike the previous methods of mounting dental models, where uncured mold material was embedded into structures used to hold the model to the support (e.g., dovetails on the support or pins embedded into the model), the current invention preferably allows for the dental model to be removed from the support with minimal effort and minimal or no damage to the dental model.

Additional benefits of the present invention include the ability of the stretch release pressure sensitive adhesive to securely attach the dental model to the mounting surface of a support. In addition, the backing of the stretch release pressure sensitive adhesive can conform to uneven surfaces of the dental model and/or the mounting surface of the support. This allows for the stretch release pressure sensitive adhesive to contact more surface area of the dental model and/or the support. Dental models constructed from hard materials can also be secured to the support through the use of the stretch release pressure sensitive adhesive. Dental models constructed of hard materials are desirable, as hard materials are easier to carve or shape, and a higher resolution of tooth structure can be achieved as compared with softer dental mold materials. Also, the backing and stretch release pressure sensitive adhesive may provide some vibration dampening between the support and the attached dental model. So, for example, vibrations from a computer automated design system in which the dental model and support are mounted can be dampened by the presence of the backing. An additional benefit of the present invention is the convenience of using an inexpensive ready-made tape (i.e., backing and stretch release pressure sensitive adhesive) that is not “set” into the dental model material or that does not require a solvent to separate the dental model from the support. Other advantages of the present invention are discussed below.

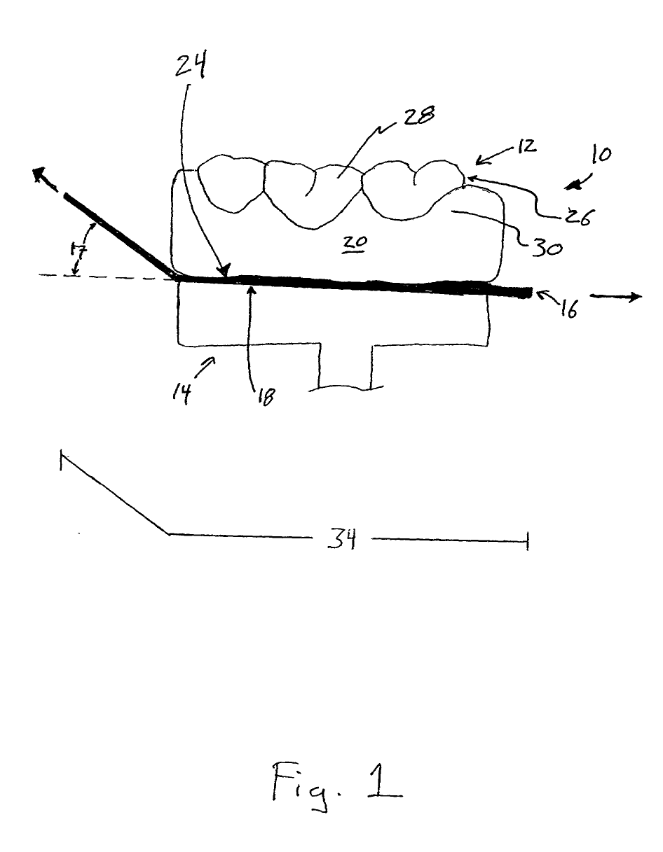

FIG. 1 shows one embodiment of an apparatus 10 according to the present invention. The apparatus 10 includes a dental model 12, a support 14 and a stretch release pressure sensitive adhesive 16 located between the dental model 12 and the support 14. The support 14 includes a mounting surface 18 on which the stretch release pressure sensitive adhesive 16 is secured. In the present example, the stretch release pressure sensitive adhesive 16 attaches the dental model 12 to the mounting surface 18, where the adhesive 16 is stretch removable when pulled. Stretch removable means that a pressure sensitive adhesive, when pulled and elongated, detaches from a substrate surface, such as the support and the dental model, without significant damage to the substrate surface, and without leaving a significant residue, visible to the unaided human eye, on either the support or the dental model.

In the illustrated embodiment, the stretch release pressure sensitive adhesive 16 is in the form of an adhesive sheet. The sheet of the adhesive 16 is extensible to allow the dental model 12 and the support 14 to be separable by stretching the stretch release pressure sensitive adhesive 16. The support 14 and the dental model 12 are separated by stretching the stretch release pressure sensitive adhesive 16 at an angle 17 that is about thirty five (35) degrees or less from the mounting surface 18. The angle at which the adhesive is stretched can be measured above or below the plane of the mounting surface 18.

The stretch release pressure sensitive adhesive 16 can include any number of pressure-sensitive adhesives, as long as they are stretch removable, as defined above. Preferably, the adhesive itself is stretch removable as defined above. The stretch release pressure sensitive adhesive 16 is preferably suitable for use on mold material of dental models. The adhesion properties may, e.g., be greater than or equal to about 13 N/dm; be greater than or equal to about 25 N/dm; be less than or equal to about 100 N/dm; or be less than or equal to about 200 N/dm, where all adhesion properties are measured at a peel angle of 180 degrees according to PSTC-1 and PSTC-3 and ASTM D 903-83 at a peel rate of 12.7 cm/min. In addition, the adhesion properties may be in a range between any combination of the stated adhesion properties (e.g., from about 13 N/dm to about 200 N/dm or about 25 N/dm to about 100 N/dm). Adhesives having higher peel adhesion levels usually require backings having higher tensile strength.

Pressure-sensitive adhesives suitable for this invention include, for example, those based on natural rubbers, synthetic rubbers, tackified rubber adhesives, olefins, silicones, polyisoprenes, polybutadienes, polyurethanes, styrene block copolymers such as styrene-isoprene-styrene and styrene-butadiene-styrene block copolymers, and other elastomers, polyvinyl ethers, poly(meth)acrylates (including both polyacrylates and polymethacrylates), polyolefins; and tackified or untackified acrylic adhesives such as copolymers of isooctylacrylate and acrylic acid, which can be polymerized by radiation, solution, suspension, or emulsion techniques.

If desired, tackifiers may be added to a base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, oils, plasticizers, antioxidants, ultraviolet (“UV”) stabilizers, hydrogenated butyl rubber, pigments, and curing agents. Crosslinked adhesives can also be used, especially those pressure-sensitive adhesives crosslinked to give high shear strengths. Additional adhesives include those that are crosslinked by radiation with or without a chemical crosslinking agent. Such adhesives that have high shear strength provide low debonding force and can easily be removed when stretched.

An example of a stretchable block copolymers would include those formed using a tackified elastomer with an A-B-A type block copolymer structure, wherein the A blocks and B blocks are configured in linear, radial or star configurations. The A block is formed of a mono-alkenylarene (preferably polystyrene) block having a molecular weight between about 4000 and about 50,000. In one embodiment, the A block content is about 10 weight percent to about 50 weight percent. In an additional embodiment, A blocks may be formed from alpha-methylstyrene, t-butyl-styrene and other ring-alkylated styrenes, as well as mixtures thereof. In one embodiment, the B block is formed of an elastomeric conjugated diene, generally polyisoprene, polybutadiene or copolymers thereof having an average molecular weight from about 5000 to about 500,000. The B block dienes can also be hydrogenated. In one embodiment, the B block content is about 90 percent to about 50 percent of the block copolymer. The tackifying components for the stretchable block copolymers generally are solid tackifying resins, liquid tackifiers, plasticizers or mixtures thereof. In one embodiment, liquid tackifiers or plasticizers for use in the adhesive polymer include napthenic oils, paraffin oils, aromatic oils, mineral oils or low molecular weight rosin esters, polyterpenes and C-5 resins.

The pressure sensitive adhesive may, e.g., be based on poly(meth)acrylates (e.g., a polymethacrylic or polyacrylic pressure sensitive adhesive). Poly(meth)acrylic pressure sensitive adhesives are derived from, for example, at least one alkyl ester monomer such as, for example, isooctyl acrylate, isononyl acrylate, 2-methyl-butyl acrylate, 2-ethyl-hexyl acrylate and n-butyl acrylate; and an optional co-monomer component such as, for example, (meth)acrylic acid, vinyl acetate, N-vinyl pyrrolidone, (meth)acrylate, (meth)acrylamide, a vinyl ester, a fumarate, a styrene macromer, or combinations thereof. Additionally, the poly(meth)acrylic pressure sensitive adhesive may be derived from about 0 to about 20 weight percent of acrylic acid and about 100 weight percent to about 80 weight percent of at least one of isooctyl acrylate, 2-ethyl-hexyl acrylate or n-butyl acrylate composition, preferably isooctyl acrylate. In an additional embodiment, the adhesive is derived from about 2 weight percent to about 10 weight percent acrylic acid, about 90 weight percent to about 98 weight percent of isooctyl acrylate, and about 2 weight percent to about 6 weight percent styrene macromer.

The poly(meth)acrylate pressure sensitive adhesives can be synthesized by a variety of free-radical polymerization processes, including solution, radiation, bulk, dispersion, emulsion, and suspension polymerization processes. Bulk polymerization methods, such as the continuous free radical polymerization method described in U.S. Pat. Nos. 4,619,979 (Kotnour et al.) or 4,843,134 (Kotnour et al.), the essentially adiabatic polymerization methods using a batch reactor described in U.S. Pat. No. 5,637,646 (Ellis), and the methods described for polymerizing packaged pre-adhesive compositions described in International Publication No. WO 96/07522 (Hamer et al.) may also be utilized.

The poly(meth)acrylate pressure sensitive adhesive useful with the present invention can include conventional additives such as tackifiers (wood rosin, polyesters, etc.), plasticizers, flow modifiers, neutralizing agents, stabilizers, antioxidants, fillers, colorants, and the like. Initiators that are not copolymerizable with the monomers used to prepare the (meth)acrylate copolymer can also be used to enhance the rate of polymerization and/or crosslinking. These additives are incorporated in amounts that do not materially adversely affect the desired properties of the pressure sensitive adhesives. Typically, they can be mixed into these systems in amounts of about 0.05 weight percent to about 25 weight percent, based on the total weight of the composition.

Furthermore, the pressure sensitive adhesive used in the present invention can be a single pressure sensitive adhesive or it can be a combination of two or more pressure sensitive adhesives. Suitable adhesives are inherently stretchy, as in styrene block copolymers, or they can be reinforced to increase cohesive strength and stretchability. The stretch release pressure sensitive adhesive used in the present invention can take the form of a continuous layer or a discontinuous layer (e.g., porous layer). This may result from, e.g., solvent coating, screen printing, roller printing, melt spraying, stripe coating, or laminating processes, etc. Porosity can also occur by perforating a continuous adhesive layer. An adhesive can have a wide variety of thicknesses so long as it possesses pressure sensitive adhesive characteristics, and preferably, stretch removable pressure sensitive adhesive characteristics, with thicknesses preferably ranging from about 25 micrometers to about 1,000 micrometers, preferably from about 50 micrometers to about 400 micrometers.

The dental model 12 of FIG. 1 includes a quantity of mold material 20. The mold material 20 is shaped to have a base surface 24 and an upper surface 26, where the upper surface 26 replicates one or more oral structures (e.g., teeth, gingival tissue, space defined by two or more teeth, etc.). The stretch release pressure sensitive adhesive 16 attaches the base surface 24 to the mounting surface 18 of the support 14. The upper surface 26 represents oral structures. In the depicted embodiment, the oral structures include a model of one or more teeth 28 and gingival tissue 30 of a patient's mouth.

The dental model 12 shown in FIG. 1 has a generally straight, elongate configuration with replicas of only three teeth 28. However, it is understood that additional oral structures can be replicated in the dental model 12, including portions of one or more teeth. For example, dental model 12 can include replicas of a single tooth, or a portion thereof. As another alternative, the dental model 12 may have a generally, overall “U”-shaped configuration in plan view with a sufficient number of teeth 28 to represent all of the teeth in a patient's dental arch, or an overall, generally “J”-shaped configuration with a sufficient number of teeth 28 to represent one-half of a patient's dental arch (also known as a quadrant). Models having other quantities of teeth and/or oral structure are also possible.

To match the configurations of the dental models, the layer of stretch release pressure sensitive adhesive 16 can be made in a range of configurations. For example, the layer of stretch release pressure sensitive adhesive 16 can be rectangular, square, straight, curved, “J”-shaped, “U”-shaped, circular, polygonal, or other geometric shapes. In addition, two or more layers of the adhesive 16 can be used to mount and secure a dental model to the support.

The mold material used to create the dental model 12 can be any material that is useful for making a dental model. Examples of suitable materials include gypsum, acrylate-based and methacrylate-based resins and composites, epoxy-based resins and composites, phosphate-bound refractory materials and silicones. The mold material may, e.g., have a relatively short hardening time and begin to cure once components of the material are mixed together. Alternatively, the mold material may, e.g., be made of a material that can be hardened upon command (for example, by the use of a curing light that initiates a photopolymerization reaction in the mold material).

The dental model 12 may be made according to any one of a number of techniques. For example, to obtain a positive dental model, an impression of desired areas of the patient's oral cavity is first obtained. To prepare an impression, a quantity of curable dental impression material is placed in an impression tray, and the tray is then positioned in the patient's oral cavity such that the impression material fills and surrounds the selected area of interest. Once the impression material has cured or at least partially cured, the impression material along with the tray is removed from the oral cavity.

To make the dental model 12 from the impression described above, the mold material is poured or otherwise placed in the recesses of the cured impression material. Once the mold material has hardened, the impression material is removed from the resulting model. When made properly, the tooth portions and gingival portions provide an accurate physical replica of corresponding tooth portions and gingival portions of the patient's oral cavity. In another embodiment, the impression itself serves as the dental model to be secured via the present invention.

A variety of dental impression materials are commercially available and may be used in accordance with the methods of the present invention. Elastomeric impression materials are generally preferred because the flexibility of the elastomeric material when cured enables the material to be readily removed from the oral cavity even when undercut areas, recesses and the like are present in the tooth structure. However, non-elastomeric impression material (such as plaster of Paris) may also be used.

Elastomeric dental impression materials are often considered to fall in one of five major classes: reversible hydrocolloids, irreversible hydrocolloids, polysulfides, silicones and polyethers, of which the last four are thermosetting. An example of an irreversible hydrocolloid impression material is UNIJEL-2 brand alginate impression material from 3M Unitek Corporation. An example of a silicone dental impression material is EXPRESS brand impression material from 3M ESPE (St. Paul, Minn.).

In one embodiment, the sheet of the stretch release pressure sensitive adhesive 16 has a predetermined length, as shown at 34 on FIG. 1. The predetermined length 34 of the stretch release pressure sensitive adhesive 16 is shown in an unstretched state. The predetermined length 34 is a function of the size and shape of the dental model 12, where the length of the dental model will typically be a factor in determining the predetermined length 34 of the stretch release pressure sensitive adhesive 16. For example, the length 34 of the stretch release pressure sensitive adhesive 16 is greater than at least one dimension of the width or length of the dental model 12 so that at least a portion of the stretch release pressure sensitive adhesive 16 projects past the perimeter of one or both of the base 24 of the dental model 12 and the support 14. A user can then grasp the projecting portion of the stretch release pressure sensitive adhesive when release of the dental model 12 is desired. So, for example, the length 34 of the stretch release pressure sensitive adhesive 16 is greater than the length of the dental model 12.

In one embodiment, the stretch release pressure sensitive adhesive 16 is removable from the dental model 12 and the support 14 by stretching the sheet of stretch release pressure sensitive adhesive 16 to at least about 50% of the predetermined length 34 of the sheet. It may be preferred that the sheet of stretch release pressure sensitive adhesive 16 has a sufficient tensile strength at break so that the adhesive sheet 16 will not rupture prior to the separation of the dental model 12 and the support 14.

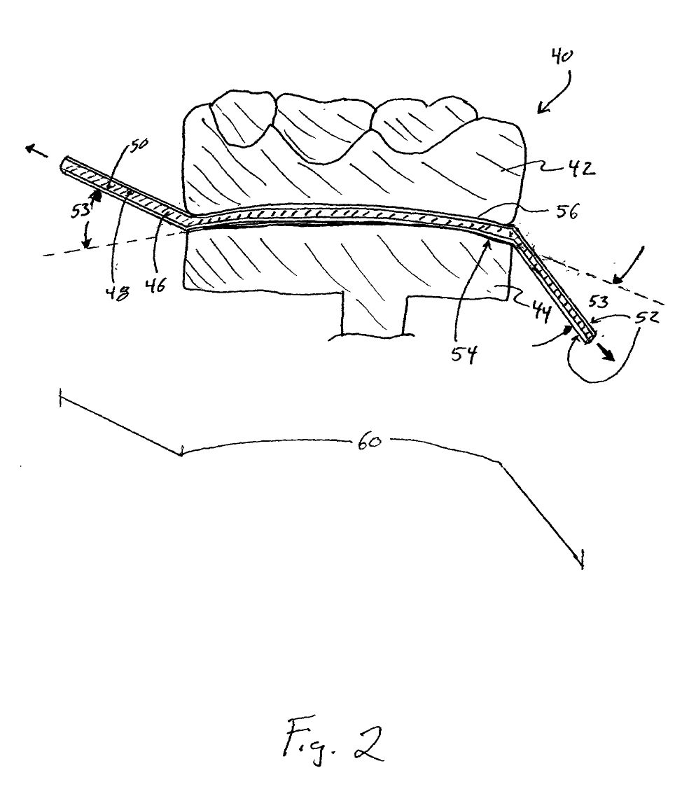

The stretch release pressure sensitive adhesive 16 of FIG. 1 may preferably consist essentially of a self-supporting layer or layers of stretch release pressure sensitive adhesive. Alternatively, the dental models may be affixed using stretch release pressure sensitive adhesive on a backing. FIG. 2 illustrates in an enlarged, partial cross-sectional view, of a construction of apparatus 40 that further includes a backing 46 with a first major surface 48 and a second major surface 50, where a layer of stretch release pressure sensitive adhesive 52 is disposed on each of the first major surface 48 and the second major surface 50. In one embodiment, the backing and the stretch release pressure sensitive adhesive form separate phases (i.e., are in separate layers). Other structures are possible.

The backing 46 and the stretch release pressure sensitive adhesive 52 are extensible to separate the dental model 42 and the support 44, where the backing has a tensile strength at break so that the backing 46 will not rupture prior to the removal of the stretch release pressure sensitive adhesive 52 from the dental model 42 and the support 44. In one embodiment, the dental model 42 and the support separate by stretching the backing 46 and the adhesive 52 at an angle 53 of about 35 degrees or less from the mounting surface 54 of the support 44. The angle at which the backing 46 and adhesive 52 are stretched can be measured above or below the plane of the mounting surface 54.

FIG. 2 further illustrates an embodiment in which a dental model and/or a support do not have planar surfaces with respect to each other. In FIG. 2, the dental model 42 is shown with a non-planar surface adjacent the support 44. In addition, the base surface 56 of the dental model 42 need not be flat, as the backing 46 can accommodate a degree of roughness and/or surface curvature of the base surface 56. The support 44 also is shown having a non-planar surface adjacent the support 44. In the present illustration, the dental model 42 and the support 44 each have curved surfaces that are attached by the backing 46 and the adhesive 52. Other surface shapes and profiles for the support 44 and/or the model 42 are possible, where the backing 46 and the adhesive 52 conform to both the surface structure of the support 44 and/or the model 42, and the overall surface profile of the support 44 and/or model 42. In such situations, the stretch angle 53 may be measured from, e.g., a tangent line at the release point between the adhesive 52 and the support 44.

In one embodiment, examples of suitable backings having a stretch release pressure sensitive adhesive are described in U.S. Pat. Nos. 5,516,581 to Kreckel et al., and 6,231,962 to Bries et al. entitled “Removable Foam Adhesive Tape”. An additional example of a backing with a stretch releasable pressure sensitive adhesive is the COMMAND brand adhesive strip sold by 3M Company (St. Paul, Minn.).

Materials suitable for the backing 46 may include, for example, highly extensible polymeric sheet materials having a high tensile strength. The highly extensible polymeric sheet materials may, for example, exhibit a lengthwise elongation at break of about 50% or greater of the predetermined length of the backing; from about 150% or greater of the predetermined length of the backing; or about 350% or greater of the predetermined length of the backing. At the other end of the elongation at break, the sheet materials may exhibit elongation at break of about 700% or less of the predetermined length of the backing; or from about 1200% or less of the predetermined length of the backing. The elongation at break can include ranges between pairs of the stated percentages for the lengthwise elongation at break.

The highly extensible polymeric sheet materials may exhibit substantial inelasticity, e.g., having less than about 50% elastic recovery after being stretched, less than about 30% elastic recovery after being stretched, or less than about 20% elastic recovery after being stretched. In addition, the highly extensible polymeric sheet materials may exhibit a Young's modulus of at least about 689 KPa; at least about 17,237 KPa; at least about 20,684 KPa; at least about 34,474 KPa; less than about 499,870 KPa; less than about 344,738 KPa; or the Young's modulus can include ranges between pairs of the stated Young's moduli. If the Young's modulus is too high, it may be difficult to stretch the backing sufficiently to cause the adhesive to cleanly release upon stretching. If the Young's modulus is too low, the backing may lose its plastic character and become rubbery.

The tensile strength at break of the backing is, however, preferably sufficiently high so that the backing will not rupture prior to the removal of the adhesive and backing from the surface to which it has been adhered (e.g., the dental model and the support). The tensile strength at break of the backing may preferably be at least about 29,647 KPa; at least about 36,542 KPa; or at least about 43,437 KPa.

The backing 46 may, for example, be a polymeric foam film. Some representative examples of materials suitable for the backing 46 include polyolefins, such as polyethylenes, including high density polyethylenes, low density polyethylenes, linear low density polyethylenes, and linear ultra low density polyethylenes, polypropylenes, and polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadiene-styrene copolymers, and ethylene/propylene copolymers; acrylic polymers and copolymers; and combinations of the foregoing. Mixtures or blends of any plastic or plastic and elastomeric materials such as polypropylene/polyethylene, polyurethane/polyolefin, polyurethane/polycarbonate, polyurethane/polyester, can also be used. The backing 46 can be in the form of single or multi-layer films, non-woven films, porous films, foam-like films, and combinations of the foregoing. The backing can also be prepared from filled materials, such as, for example, filled films, e.g., calcium carbonate filled polyolefins. The backing may be selected from polyethylene and polypropylene films, with an example of a material being linear low density and ultra low-density polyethylene films.

The backing 46 can be made by any known method of film forming, such as, for example, extrusion, co-extrusion, solvent casting, foaming, non-woven technology, and the like. The backing 46 can have any thickness so long as it possesses sufficient integrity to be processable and handleable. The thickness of the adhesive 52 on the backing 46 can range from about 25 micrometers to about 1,000 micrometers, which includes from about 50 micrometers to about 400 micrometers.

Tapes (i.e., backings coated with adhesive) used in this invention may be produced by any conventional method for preparing pressure-sensitive adhesive tapes. For example, the adhesive can either be directly coated onto the backing, or it can be formed as a separate layer and then later laminated to the backing. In some cases, in order to improve adhesion of the adhesive layer to the backing, the backing can be pretreated prior to the coating step or the laminating step in one or more of the following ways: corona discharge, plasma discharge, flame treatment, electron beam irradiation, ultraviolet radiation, acid etching, or chemical priming. Such pretreatments can be carried out with or without reactive chemical adhesion promoters such as hydroxyethyl acrylate or hydroxyethyl methacrylate, or other reactive species of low molecular weight. Corona discharge pretreatment may be preferred if a polymeric film backing is used.

The stretch release pressure sensitive adhesive 52 and the backing 46 have a predetermined length, one example of which is shown at 60 on FIG. 2. The stretch release pressure sensitive adhesive 52 and the backing 46 are shown in their unstretched state. The predetermined length 60 is a function of the size and shape of the dental model 42, where the length of the dental model 42 will be a factor in determining the predetermined length 60 of the stretch release pressure sensitive adhesive 52 and the backing 46. For example, the length 60 of the stretch release pressure sensitive adhesive 52 and the backing 46 is preferably greater than at least one dimension of the width or length of the dental model 42 so that at least a portion of the stretch release pressure sensitive adhesive 52 projects past the perimeter of one or both of the base 56 of the dental model 42 and the support 44. A user can then grasp the projecting portion of the stretch release pressure sensitive adhesive when release of the dental model 42 is desired. So, for example, the length 60 of the stretch release pressure sensitive adhesive 52 is greater than the length of the dental model 42. Alternatively, the length 60 of both the stretch release pressure sensitive adhesive 52 and the backing 46 in the depicted embodiment are greater than the length of the dental model 42.

The stretch release pressure sensitive adhesive 52 may be removable from the dental model 42 and the support 44 by stretching the backing 46 and the adhesive 52 to, e.g., at least about 50% of the predetermined length 60 of the backing 46. It may be preferred that the backing 46 and the sheet of stretch release pressure sensitive adhesive 52 have sufficient tensile strength at break so that the backing 46 and adhesive 52 will not rupture prior to the separation of the dental model 42 and the support 44.

In an additional embodiment, the backing 46 is not only extensible, but is also substantially non-recoverable. Substantially non-recoverable as used herein means that the stretched backing does not snap, or quickly move, back in a direction opposite the stretch. In addition, the stretched backing may retain substantially the configuration to which the backing was stretched. The nonrecoverable nature of the backing may reduce the chance of, or prevent, the backing from hitting the user, the dental model or the support when the stretched backing is released.

To match the configurations of the dental models, the backing 46 coated with the stretch release pressure sensitive adhesive 52 can be made in a range of configurations. For example, the backing 46 with adhesive 52 can have a rectangular, square, straight, curved, “J”-shaped, “U”-shaped, circular, polygonal, or other geometric shape. In addition, two or more layers of the backing 46 with adhesive 52 can be used to mount and secure a dental model to the support.

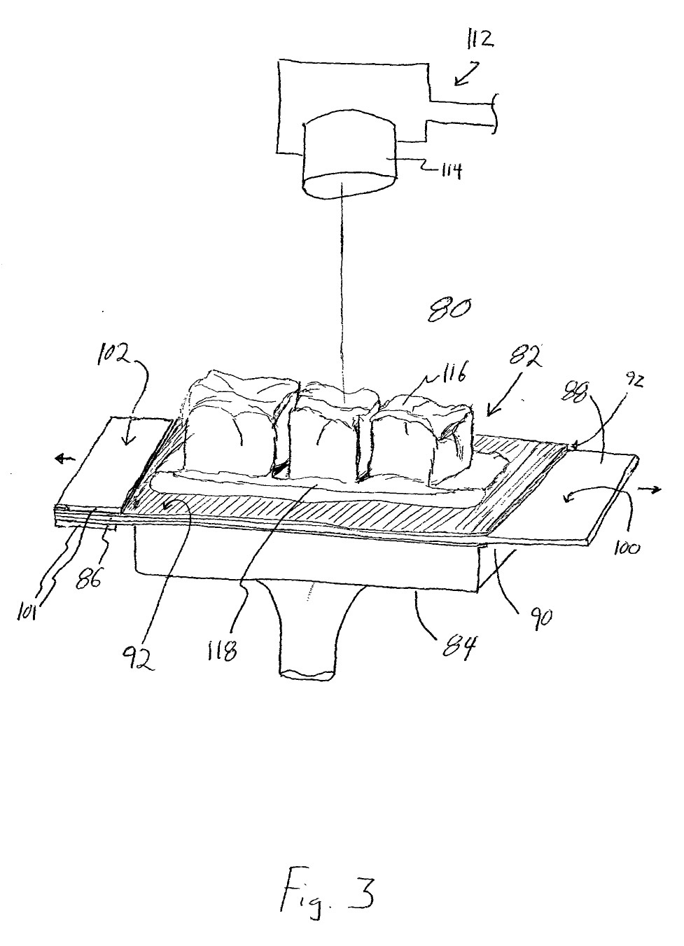

FIG. 3 shows an additional embodiment of an apparatus 80 according to the present invention. FIG. 3 includes a dental model 82, a support 84 and a backing 86 positioned at least partially between the dental model 82 and the support 84. The backing 86 includes a first major surface 88 and a second major surface 90, where a layer of the stretch release pressure sensitive adhesive 92 is disposed on both the first and second major surfaces 88 and 90. As previously discussed, the backing 86 and the stretch release pressure sensitive adhesive 92 are extensible to separate the dental model 82 and the support 84 without rupture of the backing 86.

FIG. 3 also shows the backing 86 further including a tab portion 100, where the tab portion 100 projects past at least one of the dental model 82 and support 84. In the present example, the backing 86 and the stretch release pressure sensitive adhesive 92 are stretched from the tab portion 100. The tab portion 100 in the depicted embodiment is an area of the backing 86 that is substantially free of the stretch release pressure sensitive adhesive 92. In this embodiment, only the backing forms the tab portion 100.

The backing 86 can further include a tab portion 102 that, in the depicted embodiment, is on the opposite side of the backing 86 from tab 100. The tab portion 102 projects past at least one of the dental model and the support, where the backing 86 and the stretch release pressure sensitive adhesive 92 are stretched from at least the second tab portion 102. The stretch release pressure sensitive adhesive 92 is present in the area of the tab portion 102, but is covered so that any of the stretch release pressure sensitive adhesive located on the tab portion 102 is not exposed. In this example, a sheet 101, or layer, of material covers the stretch release pressure sensitive adhesive to prevent the exposure of the adhesive.

It should be understood that the tab portion 100 and the tab portion 102 need not have different constructions (e.g., region free of adhesive and region with a release liner covering adhesive), but can have the same construction (e.g., both tab portions being free of adhesive or both tab portions having a release liner covering the adhesive).

The tab portions can include a variety of different features, e.g., grip ledges, folds, loops, and other devices to facilitate removal of the backing 86 and pressure sensitive adhesive 92. The tabs can also be in a variety of shapes and sizes. For example, the backing 86 may be larger than the dental model 82 and/or support 84 in substantially all directions, such that the backing 86 projects past the dental model 82 and the support 84 in all directions. In such an embodiment, the backing 86 may form a single continuous tab extending about the periphery of the dental model 82 and/or support 84.

The tabs may also be formed from other parts of the backing, such as by making a fold in the backing during manufacture, which can be done before or after application of the adhesive. Alternatively, the backing can be in the form of two pieces, optionally with overlapping ends, each of which have a nonadhesive portion, i.e., a portion free of exposed adhesive. These ends can be free of adhesive or have at least one release liner covering the adhesive at the ends.

The tabs are particularly advantageous for the removal of the dental model from the support. A user grips the dental model alone or grips both the dental model and the support. The user then pulls the stretch releasable adhesive coated backing in a direction within thirty-five degrees above or below the plane of the support. As the stretch releasable adhesive coated backing releases from the dental model, the user maintains a hold on the dental model as the model is released from the support. In addition, little or no residue of the stretch releasable adhesive is retained on the dental model. The tab may be colored to show its location and/or boundaries, and it may be printed with an arrow showing which way to pull it to release the dental model and the support. Further directions could be on a wrapper or the box containing the stretch release pressure sensitive adhesive or a kit of the stretch release pressure sensitive adhesive and other dental articles.

The embodiment shown in FIG. 3 further includes an optional data collection apparatus 112. The data collection apparatus 112 is used to collect an electronic data set from the dental model 82. The data collection apparatus 112 may include, e.g., a laser scanner 114 that is brought into proximity with the dental model 82 in order to collect electronic data regarding the spatial characteristics of the tooth portions 116 and the gingival portions 118. As the data set is collected, the dental model 82 and the laser scanner 114 are moved relative to each other so that all of the surfaces of interest of the tooth portions 116 and the gingival portions 118 are scanned. For example, the scanner 114 may be held stationary while the support 84 moves along a path to enable the laser beam to scan the entire areas of interest. Alternatively, the support 84 is held stationary while the laser scanner 114 moves about the dental model 82. In an additional embodiment, both the laser scanner 114 and the dental model 82 are moved during collection of the data set.

Moreover, the set of electronic data may be used for other dental (including orthodontics) procedures performed by the same party collecting the data or by a third party. Examples of such procedures include use of the electronic data as a patient record, use for patient education, use for insurance authorization or verification, for fabrication of a prosthetic, for diagnosis, for treatment planning and for transmittal to third parties (e.g., a dental laboratory remote from the dental office). Transmission of the electronic data in any such methods may be, e.g., to a computer located remote from the data collection apparatus, to a computer-aided milling system, to a third party, etc.

Other methods of collecting electronic data include mechanical profilometry, optical imaging (e.g., a camera) and other types of scanning procedures. Once the scanning operation has been completed, the dental model 82 is removed from the support 84. A user can release the dental model 82 from the support 84 by stretching the backing 86 and the stretch release pressure sensitive adhesive 92 from either the tab portions 100 or 102 alone. Alternatively, the user can release the dental model 82 and the support 84 by stretching both tab portions 100 and 102 either separately or essentially simultaneously.

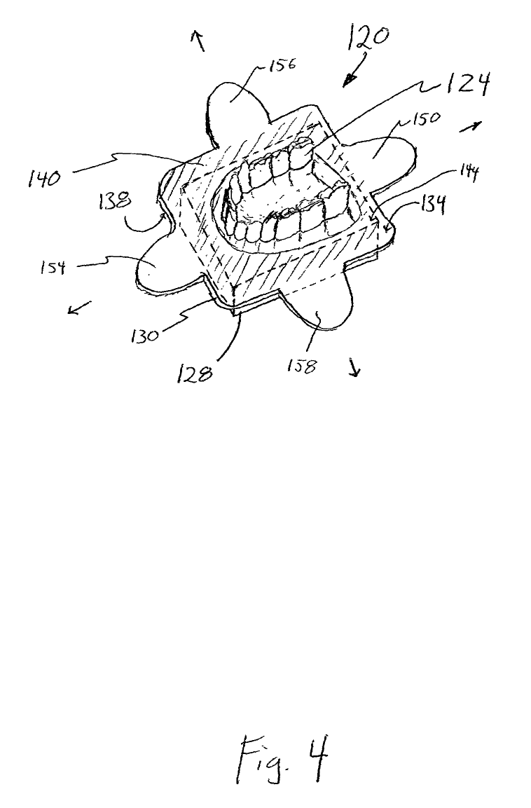

FIG. 4 shows an additional embodiment of an apparatus 120 according to the present subject matter. The apparatus 120 includes a dental model 124 and a support 128. The dental model 124 and support 128 are similar to those structures previously described, where the dental model 124 is an example of an overall “U”-shaped configuration of a patient's dental arch. The apparatus 120 further includes a backing 130, positioned at least partially between the dental model 124 and the support 128, having a first major surface 134 and a second major surface 138.

A layer of stretch release pressure sensitive adhesive 140 is disposed on the first major surface 134 and the second major surface 138. The backing 130 and the stretch release pressure sensitive adhesive 140 are extensible to separate the dental model 124 and the support 128 without rupture of the backing 130.

FIG. 4 also shows the backing 130 further including a first tab portion 150, a second tab portion 154, a third tab portion 156 and a fourth tab portion 158. One or more of the tab portions preferably project past at least one of the dental model 124 and support 128. In the present example, the backing 130 and the stretch release pressure sensitive adhesive 140 are stretched from one or more of the tab portions.

In the depicted embodiment, the first tab portion 150 opposes the second tab portion 154 across the mounting surface, and the third tab portion 156 opposes the fourth tab portion 158 across the mounting surface 144. The backing 130 and the stretch release pressure sensitive adhesive 140 are stretchable from any one of the first tab portion 150, the second tab portion 154, the third tab portion 156 and the fourth tab portion 158.

In the depicted embodiment, the first, second, third and forth tab portions 150, 154, 156 and 158 are areas of the backing 130 that are substantially free of the stretch release pressure sensitive adhesive 140. In this embodiment, only the backing forms the tab portions 150, 154, 156 and 158. Alternatively, the stretch release pressure sensitive adhesive 140 is present in the area of the tab portions 150, 154, 156 and 158, but is covered, as previously described, so that any of the stretch release pressure sensitive adhesive located on the tab portions 150, 154, 156 and 158 is not exposed.

A user can release the dental model 124 from the support 128 by grasping and pulling the backing 130 and the stretch release pressure sensitive adhesive 140 from either the first, second, third or fourth tab portions 150, 154, 156 or 158 alone. Alternatively, the user can release the model 124 and the support 128 by stretching both the opposing first and second tab portions 150 and 154, and/or the opposing third and fourth tab portions 156 and 158, either sequentially or simultaneously.

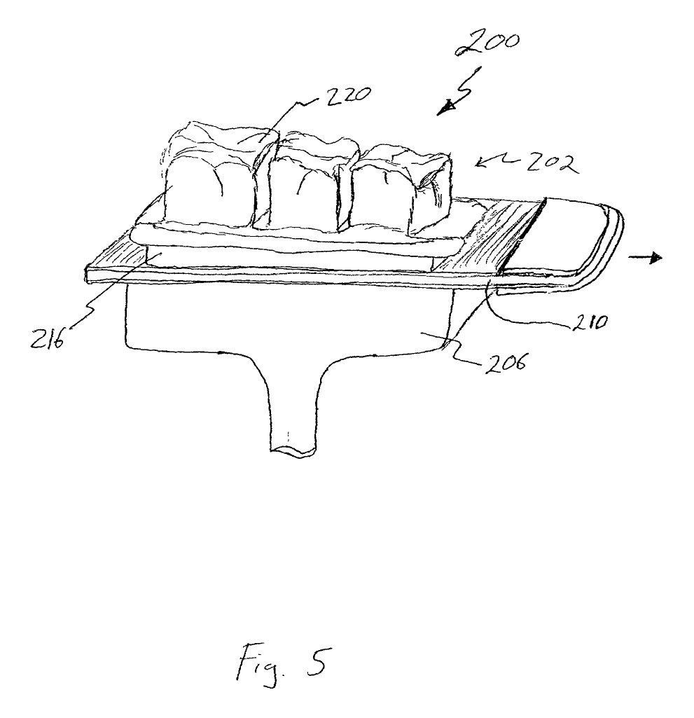

FIG. 5 shows an additional embodiment of an apparatus 200 according to the present invention. FIG. 5 includes a dental model 202, a support 206 and a backing 210 positioned at least partially between the dental model 202 and the support 206. The dental model 202, the support 206 and the backing 210 having the stretch release pressure sensitive adhesive are as previously described. In addition, the apparatus 200 further includes a holder 216, where the holder 216 is secured to the dental model 202 and the stretch release pressure sensitive adhesive attaches the holder 216 to the support 206.

In the present embodiment, the holder 216 has an elongated shape with a rectangular configuration in plan view, although other shapes are also possible. For example, the holder 216 could have a square, circular or oval configuration in plan view, which might be especially suitable for use with a model having only a single tooth portion. As another alternative, the holder 216 may have an overall, generally “U”-shaped configuration or an overall, generally “J”-shaped configuration in plan view to match the shape of a model having sufficient tooth portions to represent an entire dental arch or a quadrant respectively. In one embodiment, an example of a dental model and holder is described in U.S. Pat. No. 09/567,147 entitled “Dental Models and Methods of Fixturing the Same” (Attorney Docket No. 55581US002), which is commonly assigned to the assignee of the present invention.

The depicted holder 216 has a somewhat planar configuration with two sides. One side (i.e., a first side) of the holder 216 has a textured surface (e.g., capped stems, hooks, etc.) that is embedded in the mold material 220. Preferably, the textured surface is in contact with the mold material 220 before the mold material 220 has hardened, and remains in contact with the mold material 220 as the latter hardens so that the holder 216 is ultimately securely connected to the mold material 220. In one example, the holder 216 and the backing 210 are supplied as a single unit, where the holder 216 is secured to the backing 210 through the stretch releasable pressure sensitive adhesive. In one example, the stretch releasable pressure sensitive adhesive secures the holder 216 to the backing 210 along a surface of the holder 216 opposite the textured surface.

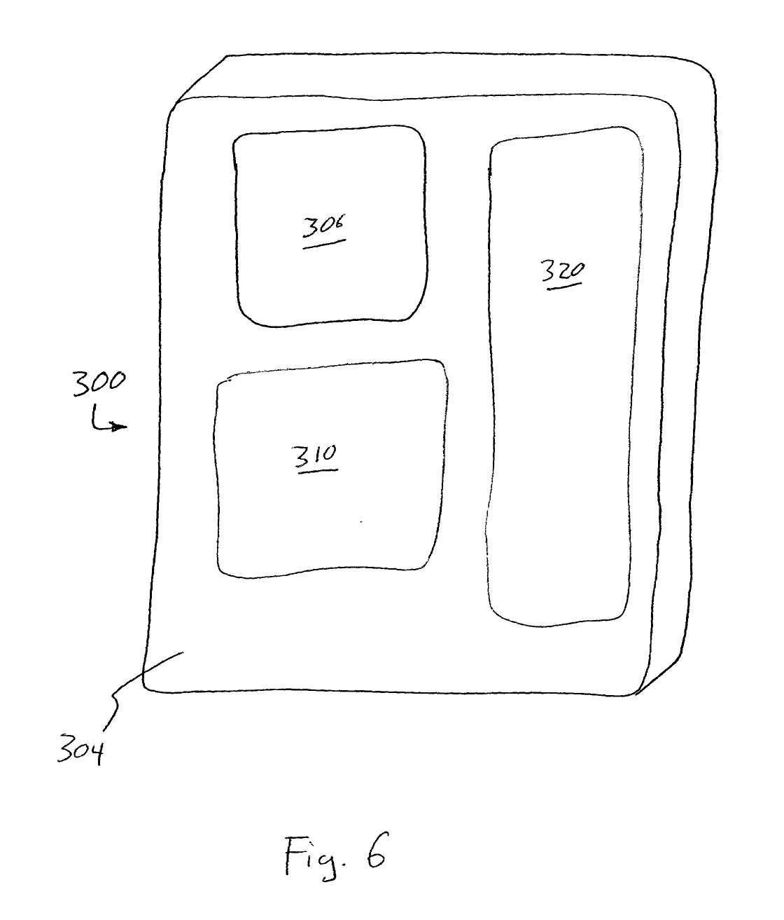

FIG. 6 illustrates one embodiment of a dental kit 300 that includes a package 304 that contains components for making the dental model as described above, or for use in the methods described above. The dental kit 300 includes dental mold material 306 and an attachment article 310. The attachment article 310 can include stretch release pressure sensitive adhesive (with or without a backing), as previously described, for attaching the dental model made from the mold material to the mounting surface of the support. The package 304 also optionally includes one or more of the following items: a dental restorative material, dental prosthetic material, a dental mold material, instructions, dental cements, dental adhesives, impression materials, shade guides, temporary dental restorative materials, a holder, a container, abrasives, tools, instruments and impression trays, a holder being pre-attached to the stretch release pressure sensitive adhesive, which are shown generally at 320. An example of a suitable dental prosthetic material is a dental mill blank such as disclosed in pending U.S. Ser. No. 09/441,577, entitled MILL BLANK FOR DENTAL PROSTHESIS (Attorney Docket No. 55156US002, filed Nov. 19, 1999), International Publication No. WO 01/35854 (Rusin, et al.), International Publication No. WO 00/40206 A1 (Rusin et al., U.S. Ser. No. 09/227,230), International Publication No. WO 01/13862 A1 (Rusin et al., U.S. Ser. No. 09/383,560), and International Publication No. WO 01/12132 A1 (Hauptmann et al.).

In addition, the stretch release pressure sensitive adhesive coatings can optionally be covered with removable materials, e.g., release liners, typically made from silicone or fluorocarbon polymeric materials or from materials coated with silicone or fluorocarbon polymers. The release liners serve to protect the adhesive, e.g., during shipping and storage, prior to use. The release liners are then readily removed from the adhesive before attaching the dental model to the mounting surface of the support.

A variety of other constructions and methods of use are also possible. For example, the models and methods described above can be used in other fields of dentistry such as orthodontics. In addition, the present invention is believed not to be limited to, or by, any specific type of mold material. In addition, the mounting surface of the support can have any number of shapes (planar, non-planar, a surface defining grooves or ridges, etc.) so long as the mounting surface provides a surface area of sufficient size to allow for the stretch release pressure sensitive adhesive to secure the dental model to the support.

Patents, patent applications, and publications disclosed herein are hereby incorporated by reference (in their entirety) as if individually incorporated. It is to be understood that the above description is intended to be illustrative, and not restrictive. Various modifications and alterations of this invention will become apparent to those skilled in the art from the foregoing description without departing from the scope of this invention, and it should be understood that this invention is not to be unduly limited to the illustrative embodiments set forth herein.

1. An apparatus comprising:
a dental model;
a support comprising a mounting surface; and
stretch release pressure sensitive adhesive located between the dental model and the support, wherein the stretch release pressure sensitive adhesive attaches the dental model to the mounting surface, and where the dental model and the support are separable by stretching the stretch release pressure sensitive adhesive at an angle no greater than about 35 degrees from the mounting surface.

2. The apparatus of claim 1, further comprising a backing that comprises a first major surface and a second major surface, wherein the stretch release pressure sensitive adhesive is disposed on each of the first major surface and the second major surface.

3. The apparatus of claim 2, wherein the backing and the stretch release pressure sensitive adhesive are extensible to separate the dental model and the support without rupture of the backing.

4. The apparatus of claim 3, wherein the backing comprises a predetermined length, and the stretch release pressure sensitive adhesive is removable from the dental model and the support by stretching the backing and the stretch release pressure sensitive adhesive to at least about 50% of the predetermined length of the backing.

5. The apparatus of claim 1, wherein the stretch release pressure sensitive adhesive comprises an adhesive sheet that is extensible and comprises a predetermined length, wherein the adhesive sheet is removable from the dental model and the support by stretching the adhesive sheet to at least about 50% of the predetermined length of the adhesive sheet.

6. The apparatus of claim 1, wherein the stretch release pressure sensitive adhesive further comprises an extensible, substantially non-recoverable backing, wherein the backing comprises a first major surface and a second major surface, and wherein a first layer of the stretch release pressure sensitive adhesive is disposed on the first major surface and a second layer of the stretch release pressure sensitive adhesive is disposed on the second major surface.

7. The apparatus of claim 6, wherein the backing comprises a first tab portion that projects past at least one of the dental model and the support.

8. The apparatus of claim 7, wherein the first tab portion comprises a portion of the stretch release pressure sensitive adhesive and further wherein the portion of the stretch release pressure sensitive adhesive located on the first tab portion is not exposed.

9. The apparatus of claim 7, wherein the first tab portion is substantially free of the stretch release pressure sensitive adhesive.

10. The apparatus of claim 7, wherein the backing comprises a second tab portion that projects past at least one of the dental model and the support, where the backing and the stretch release pressure sensitive adhesive are stretched from the second tab portion.

11. The apparatus of claim 10, wherein the second tab portion comprises a portion of the stretch release pressure sensitive adhesive and further wherein the portion of the stretch release pressure sensitive adhesive located on the second tab portion is not exposed.

12. The apparatus of claim 10, wherein the second tab portion is substantially free of the stretch release pressure sensitive adhesive.

13. The apparatus of claim 10, wherein the first tab portion opposes the second tab portion across the mounting surface.

14. The apparatus of claim 13, wherein the backing comprises a third tab portion and a fourth tab portion, wherein the third tab portion opposes the fourth tab portion across the mounting surface, and wherein the third tab portion and the fourth tab portion project past at least one of the dental model and the support.

15. The apparatus of claim 6, wherein the backing comprises a tensile strength at break so that the backing will not rupture prior to the removal of the stretch release pressure sensitive adhesive from the dental model and the support.

16. The apparatus of claim 6, wherein the backing comprises a polymeric foam structure.

17. The apparatus of claim 1, wherein the dental model comprises a base surface and an upper surface representing oral structure, wherein the stretch release pressure sensitive adhesive adheres to the base surface of the dental model.

18. The apparatus of claim 1, further comprising a holder located between the dental model and the support, wherein the stretch release pressure sensitive adhesive is located between the holder and the support.

19. The apparatus of claim 18, wherein the dental model is formed from mold material, and further wherein the holder is embedded in the mold material.

20. A method comprising:
positioning stretch release pressure sensitive adhesive between a dental model and a mounting surface of a support;
attaching the dental model to the mounting surface of the support with the stretch release pressure sensitive adhesive; and
removing the dental model from the mounting surface by stretching the stretch release pressure sensitive adhesive at an angle of no greater than about 35 degrees from the mounting surface of the support.

21. The method of claim 20, wherein the stretch release pressure sensitive adhesive comprises a predetermined length, and further wherein stretching the stretch release pressure sensitive adhesive comprises stretching the stretch release pressure sensitive adhesive to at least about 50% of the predetermined length of the stretch release pressure sensitive adhesive.

22. The method of claim 21, wherein the stretch release pressure sensitive adhesive is disposed on a backing, wherein the backing comprises a first tab portion that projects past at least one of the dental model and the support, and removing the dental model comprises stretching the backing and the stretch release pressure sensitive adhesive from the first tab portion.

23. The method of claim 22, wherein the backing comprises a second tab portion that projects past at least one of the dental model and the support, and removing the dental model comprises stretching the backing and the stretch release pressure sensitive adhesive from the first tab portion and the second tab portion.

24. The method of claim 23, wherein stretching the backing and the stretch release pressure sensitive adhesive comprises grasping the first tab portion and the second tab portion and pulling the backing and the stretch release pressure sensitive adhesive from the first tab portion and the second tab portion.

25. A kit comprising:
mold material; and
an attachment article comprising stretch release pressure sensitive adhesive for attaching a dental model made from the mold material to a mounting surface of a support, where the dental model and the support are separable by stretching the stretch release pressure sensitive adhesive at an angle no greater than about 35 degrees from the mounting surface;
at least one release liner releasably adhered to at least a portion of the stretch release pressure sensitive adhesive; and
a package containing the mold material and the attachment article.

26. The kit of claim 25, wherein the stretch release pressure sensitive adhesive further comprises a backing comprising a first major surface and a second major surface, wherein the stretch release pressure sensitive adhesive is disposed on each of the first major surface and the second major surface.

27. The kit of claim 26, wherein the backing comprises a predetermined length, and the stretch release pressure sensitive adhesive is removable from the dental model and the support by stretching the backing and the stretch release pressure sensitive adhesive to at least about 50% of the predetermined length of the backing.

28. The kit of claim 25, wherein the stretch release pressure sensitive adhesive comprises an adhesive sheet that is extensible and comprises a predetermined length, wherein the adhesive sheet is removable from the dental model and the support by stretching the adhesive sheet to at least about 50% of the predetermined length of the adhesive sheet.

29. The kit of claim 25, wherein the stretch release pressure sensitive adhesive further comprises an extensible, substantially non-recoverable backing, wherein the backing comprises a first major surface and a second major surface, wherein a first layer of the stretch release pressure sensitive adhesive is disposed on the first major surface and a second layer of the stretch release pressure sensitive adhesive is disposed on the second major surface.

30. The kit of claim 29, wherein the backing comprises a first tab portion, wherein any of the stretch release pressure sensitive adhesive located on the first tab portion is not exposed.

31. The kit of claim 29, wherein the backing comprises a first tab portion that is substantially free of the stretch release pressure sensitive adhesive.

32. The kit of claim 29, wherein the backing comprises a first tab portion and a second tab portion, wherein any of the stretch release pressure sensitive adhesive located on the first tab portion and the second tab portion is not exposed.

33. The kit of claim 29, wherein the backing comprises a first tab portion and a second tab portion, wherein the first tab portion and the second tab portion are substantially free of the stretch release pressure sensitive adhesive.

34. The kit of claim 29, further comprising a holder that comprises a textured surface.

35. The kit of claim 34, wherein the holder is adhered to the attachment article by a portion of the stretch release pressure sensitive adhesive.

36. The kit of claim 34, wherein the attachment article comprises two layers of the stretch release pressure sensitive adhesive on opposing sides of the attachment article and at least one release liner, wherein each layer of the stretch release pressure sensitive adhesive is covered by at least one of the at least one release liner.
